(19) United States
(12) Patent Application Publication
(10) Pub. No.: US 2026/0253416 A1
(43) Pub. Date: Aug. 27, 2026

(54) ARTIFICIAL INTELLIGENCE (AI) SYSTEM FOR VIDEO AND AUDIO ANALYSIS

(71) Applicant: MaxLinear, Inc., Carlsbad, CA (US)

(72) Inventors: Saju Palayur, Poway, CA (US); William Lupetini Ross-Ashikyan, San Diego, CA (US); Siddhant Baldota, San Diego, CA (US)

(73) Assignee: MaxLinear, Inc., Carlsbad, CA (US)

(21) Appl. No.: 19/542,579

(22) Filed: Feb. 17, 2026

Related U.S. Application Data
(60) Provisional application No. 63/759,130, filed on Feb. 15, 2025.

(51) Int. Cl. G06V 20/40; G06V 10/70; H04N 21/44; H04N 21/81

(52) U.S. Cl. CPC G06V 20/41; G06V 10/70; H04N 21/44008; H04N 21/812

(57) ABSTRACT

A computer-implemented method may include identifying a video stream. The computer-implemented method may include identifying one or more objects within the video stream using one or more of artificial intelligence (AI) or machine learning (ML). The computer-implemented method may include computing one or more advertisement statistics based on the one or more objects within the video stream.

### RELATED APPLICATION

This application claims the benefit of U.S. Provisional Application No. 63/759,130, filed Feb. 15, 2025, the disclosure of which is incorporated herein by reference in its entirety for all purposes.

The examples discussed in the present disclosure are related to an artificial intelligence (AI) system for video and audio analysis.

### BACKGROUND

Unless otherwise indicated herein, the materials described herein are not prior art to the claims in the present application and are not admitted to be prior art by inclusion in this section.

Consumer electronics such as TVs and set-top boxes may be enhanced with various features. For example, many consumer electronics may be enhanced to connect to the internet. These smart TVs may play video streams from various apps. Other enhancements to consumer electronics may be useful.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a computer-implemented method may include identifying a video stream. The computer-implemented method may include identifying one or more objects within the video stream using one or more of artificial intelligence (AI) or machine learning (ML). The computer-implemented method may include computing one or more advertisement statistics and/or fashion trends based on the one or more objects within the video stream.

In some examples, a device may include a processing device. The processing device may identify a video stream. The processing device may identify one or more objects within the video stream using one or more of AI or ML. The processing device may compute one or more advertisement statistics and/or fashion trends based on the one or more objects within the video stream.

In some examples, a system may include a multimedia device and a device. The device may include a transceiver. The transceiver may receive a video stream from the multimedia device. The device may include a processing device. The processing device may identify one or more objects within the video stream using one or more of AI or ML. The processing device may compute one or more advertisement statistics and/or fashion trends based on the one or more objects within the video stream.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example block diagram for video and audio analysis.

FIG. 2 illustrates an example block diagram for video and audio analysis.

FIG. 3A illustrates an example block diagram for video and audio analysis.

FIG. 3B illustrates an example diagram for video processing.

FIG. 3C illustrates an example diagram for audio processing.

FIG. 4 illustrates a process flow for video and audio analysis.

FIG. 5 illustrates a process flow for video and audio analysis.

FIG. 6 illustrates a block diagram of an example system operable to perform video and audio analysis.

FIG. 7 illustrates a diagrammatic representation of a machine in the example form of a computing device within which a set of instructions, for causing the machine to perform any one or more of the methods discussed herein, may be executed.

### DESCRIPTION

Consumer electronics (e.g., TVs, set-top boxes and other multimedia devices) may be enhanced with various features. However, consumer electronics may not include features associated with artificial intelligence (AI) and/or machine learning (ML). Using AI and/or ML in consumer electronics may enhance their functionality. Therefore, methods associated with AI and/or ML in consumer electronics may be useful.

Consumer electronics receive video streams and associated audio. Analysis of the video and/or the audio may provide various results. AI and/or ML may be used to provide advertising analytics and/or fashion-related analysis.

An AI-powered system may be designed for seamless integration into consumer electronics such as TVs, set-top boxes, and other multimedia devices. The system may enable advanced video and audio analysis, including object detection for advertisement statistics, object queueing delay estimation, and style or color recognition for fashion-related applications. The system may operate independently or be embedded within existing devices, enhancing user experiences with real-time AI processing.

The system may have various features. The system may leverage an efficient AI engine optimized for edge processing. The system may include: (1) object detection e.g., AI-driven detection of objects within video streams, providing real-time statistics for targeted advertisement analytics and object queueing delay estimation; (2) style and color recognition e.g., identifies patterns, styles, and color schemes in video streams, offering fashion-related insights and recommendations; (3) multi-mode operation e.g., can function independently or be integrated into TVs, set-top boxes, or other consumer devices; and/or (4) optimized AI Processing e.g., designed for low-latency, power-efficient AI inference, ensuring minimal impact on device performance while delivering high-accuracy analytics.

Examples of the present disclosure will be explained with reference to the accompanying drawings.

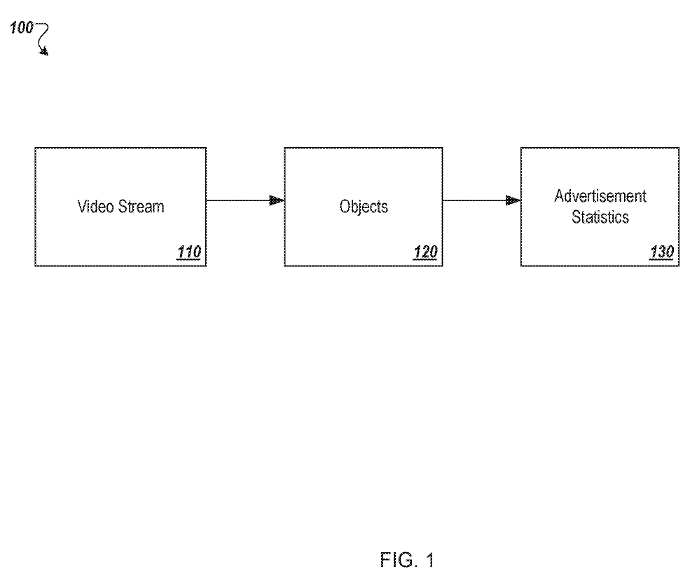

In some examples, FIG. 1 illustrates a computer-implemented method 100. The method 100 may include identifying a video stream 110. The method may include identifying one or more objects 120 within the video stream 110 using one or more of artificial intelligence (AI) or machine learning (ML). The method may include computing one or more advertisement statistics 130 based on the one or more objects 120 within the video stream 110.

The method 100 may include computing object queuing delay estimation based on the one or more objects within the video stream to facilitate real-time analytics.

The method may include training a model based on training data and a selected training algorithm to generate a trained model; and/or performing the one or more of AI or ML using the trained model.

The video stream may be received from one or more of a television, a set-top box, a computer, a user equipment (UE), an access point, or the like. Access points in public settings may also be used to provide various statistics related to advertising and/or fashion. The access points may provide various statistics related to advertising and/or fashion without modifying the processing device of the access point when compared to a baseline processing device that does not provide various statistics related to advertising and/or fashion. For example, the access point may include one or more instructions that when executed by the processing device, may provide various statistics related to advertising and/or fashion even when the processing device has not been changed from a baseline processing device that does not have the functionality of providing various statistics related to advertising and/or fashion. That is, the access point may provide various statistics related to advertising and/or fashion without additional hardware when compared to a baseline device having a baseline processing device. The access point may provide various statistics related to advertising and/or fashion based on a difference in software rather than a difference in hardware.

The AI or ML may be performed using an artificial neural network.

Modifications, additions, or omissions may be made to the components of FIG. 1 without departing from the scope of the present disclosure.

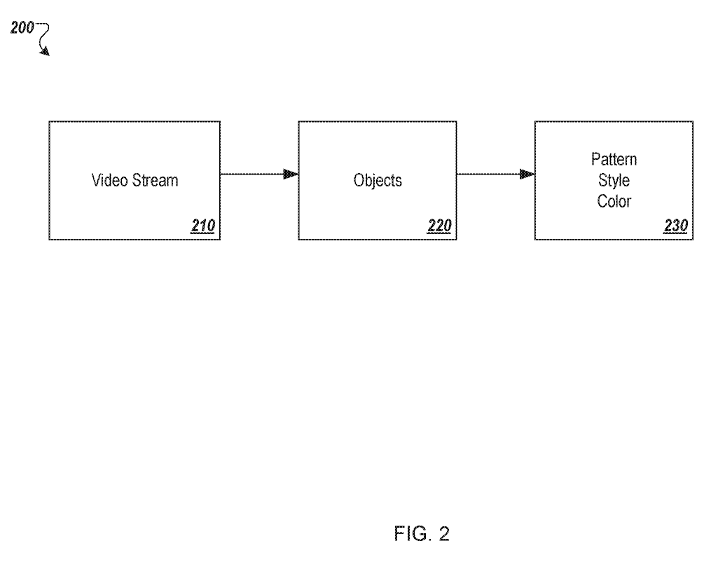

As illustrated in the example block diagram 200 in FIG. 2, a computer-implemented method may include identifying a video stream 210. The method may include identifying one or more objects 220 within the video stream 210 using one or more of artificial intelligence (AI) or machine learning (ML). The method may include identifying one or more of a pattern, a style, or a color 230 of the one or more objects 220 within the video stream 210. The method may include providing a fashion-related recommendation based on the one or more of the pattern, the style, or the color 230 of the one or more objects 220 within the video stream 210.

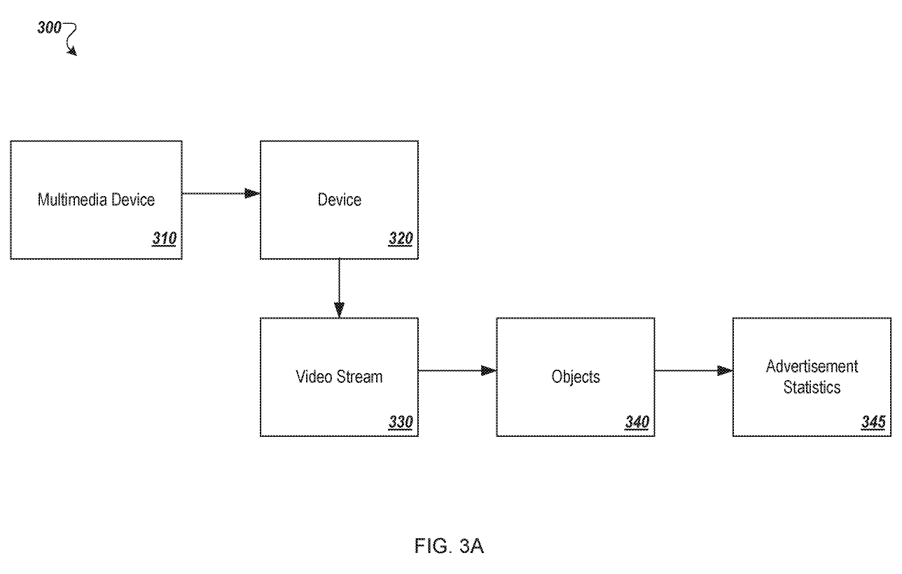

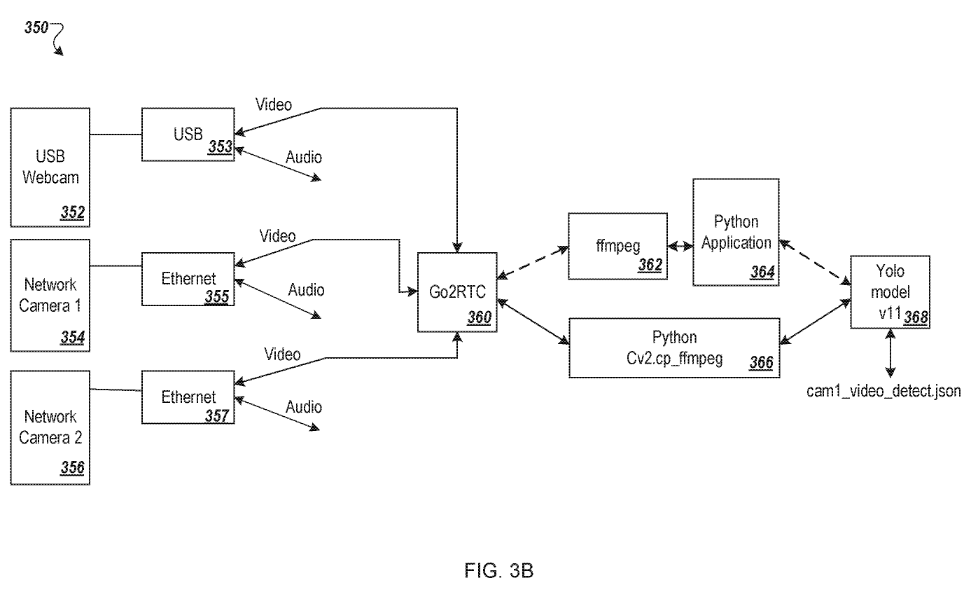

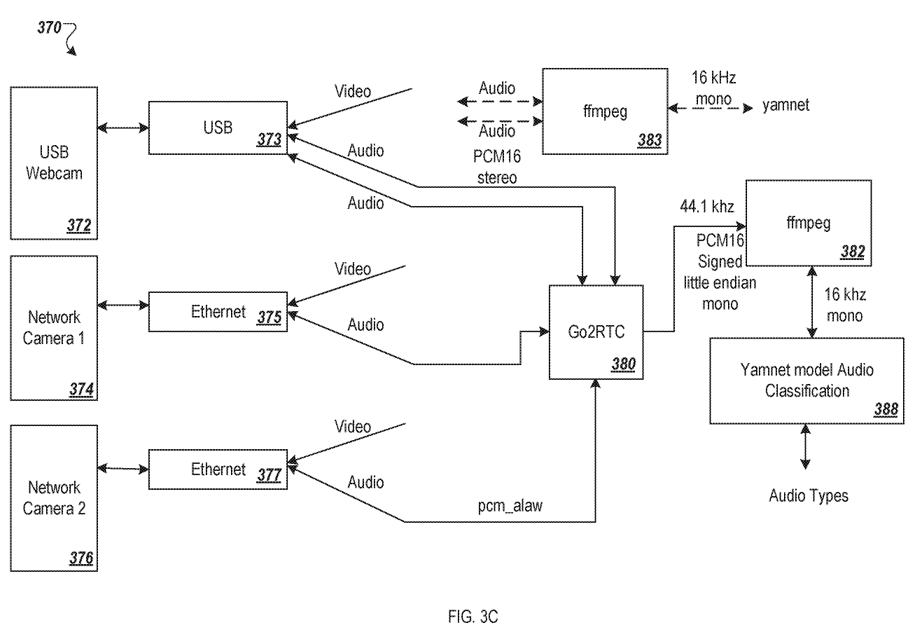

As illustrated in the block diagram 300 in FIG. 3, a system may include a multimedia device 310 and a device 320. The device 320 may include a transceiver that may receive a video stream 330 from the multimedia device 310. The device may include a processing device. The processing device may identify one or more objects 340 within the video stream 330 using one or more of artificial intelligence (AI) or machine learning (ML) and/or compute one or more advertisement statistics 345 based on the one or more objects 340 within the video stream 330. The multimedia device may include one or more of a television, a set-top box, a computer, a user equipment (UE), an access point, or the like.

The system may compute object queuing delay estimation based on the one or more objects 340 within the video stream 330 to facilitate real-time analytics. The system may identify one or more of a pattern, a style, or a color of the one or more objects 340 within the video stream 330. The system may provide a fashion-related recommendation based on the one or more of the pattern, the style, or the color of the one or more objects 340 within the video stream 330.

The system may collect a number of statistics. For example, access points in public settings may collect statistics related to fashion trends. Some examples of information that may be collected may include e.g., geography, location, the current season, the time of the day, or the like. By collecting these different statistics, fashion trends may be identified.

The system may train a model based on training data and a selected training algorithm to generate a trained model; and/or perform the one or more of AI or ML using the trained model.

Various types of artificial intelligence and/or machine learning may be used for video and audio analysis. The machine learning model may use a deep neural network including one or more of a convolutional neural network or a recurrent neural network. Alternatively or in addition, the machine learning model may use analog deep learning.

Universal Serial Bus (USB) and internet protocol (IP) cameras may be used as intelligent vision sensors with an AI-enabled, low-latency Wi-Fi® router system on Chip (SoC) platform. Using on-chip edge processing, the SoC platform may facilitate real-time video analytics at the source with applications for advertising statistics and/or fashion trends.

As illustrated in FIG. 3B, the platform 350 may ingest H.264-encoded video streams from USB (e.g., USB Webcam 352) using USB connection 353 and Ethernet-based network cameras (e.g., network camera 1 354 and/or network camera 2 356) using Ethernet connections 355, 357. The platform 350 may support multiple input sources simultaneously and handle formats like H.264 with optional audio. These streams may be routed through go-to-real time communication (Go2RTC) 360 for centralized management. Video decoding may be performed using either fast forward moving picture expert group (FFmpeg) 362 or open computer vision (OpenCV) facilitating flexible processing options. Selected frames may be analyzed using the YOLOv11 object detection model, and detection results may be output in a structured javascript objection notation (JSON) format for easy integration (e.g., cam1_video_detect.json). The platform may be optimized for efficient CPU usage and real-time object detection, with the option to record video streams on the local Wi-Fi® router for future analysis.

Go2RTC 360 may receive and multiplex video and audio streams, delivering them as WebRTC-compatible outputs. GO2RTC 360 may facilitate real-time streaming of camera feeds to downstream applications with minimal latency and seamless integration.

Video processing on the SoC platform may be implemented using: (1) FFmpeg 362 combined with a Python application 364, or (2) openCV's VideoCapture (cv2) (e.g., Python Cv2.cp_ffmpeg 366) leveraging the FFmpeg backend. Frames may be intelligently downsampled to a few per second for object detection to provide a balance between performance and system efficiency. This lightweight approach may provide that Wi-Fi® and router functions run smoothly, while still delivering accurate and timely insights for advertising statistics and/or fashion trends. For more demanding use cases, customers may adjust the frame rate based on available system headroom.

The down sampled video frames may be fed into the YOLOv11 model 368 for real-time object detection. Detection results may be saved in a structured JSON format (e.g., cam1_video_detect.json) for downstream analytics and monitoring.

This performance data highlights the capabilities of the Wi-Fi® router SoC chip, which may integrate streaming, video decoding, and AI-based object detection directly on the platform. By leveraging tools like Go2RTC 360, FFmpeg 362, and YOLOv11 model 368, the SoC facilitates real-time, low-latency video analytics using USB webcams (e.g., USB Webcam 352) or IP cameras without external processors or cloud resources. Optimized for performance and power efficiency, the SoC has applications in advertising statistics and/or fashion trends.

Wi-Fi® routers may be real-time audio processing hubs using an AI-enabled, low-latency SoC platform. With on-chip edge processing, the platform may use sound-activated services and audio analytics. Applications may include advertising statistics and/or fashion trends.

As illustrated in FIG. 3C, the platform 370 may ingest live audio streams from USB microphones, webcams (e.g., USB webcam 372) using USB connection 373, and Ethernet-based network cameras (e.g., network camera 1 374 and/or network camera 2 376) using Ethernet connections 375, 377. The platform 370 may support simultaneous multi-channel input and handle standard formats such as pulse code modulation 16 (PCM16) stereo and PCM_alaw. These streams may be routed via Go2RTC 380 for centralized, real-time management and interoperability. Audio decoding, resampling, and downmixing may be performed by FFmpeg 382, to facilitate optimal compatibility and preparation for downstream AI inference.

Go2RTC 380 may receive and multiplex multiple audio sources, delivering them to the AI engine in a unified, standardized format. The pre-processing pipeline may include downmixing stereo to mono and resampling to 16 kHz PCM which may be matched to neural network standards. For example, ffmpeg 383 may receive different audio sources which may be resampled to 16kHz mono to be provided to yamnet. Alternatively or in addition, GO2RTC may provide PCM 16 signed little endian mono to ffmpeg 382 which may resample to 16khz mono to be provided to yamnet model audio classification 388. This architecture may support scalable, low-latency audio capture from diverse endpoints throughout the a public setting.

Audio samples may be streamed to the on-chip AI/ML inference engine, where models like YAMNet (e.g., Yamnet model audio classification 388) may perform multi-class sound event detection in real time. The platform 370 may detect audio events related to advertising statistics and/or fashion trends, and hundreds of other sound categories.

The platform 370 may have several properties. The platform 370 may be localized by having AI processing occur on the Wi-Fi® gateway SoC to provide privacy, security, and ultra-low response times. The platform 370 may be efficient by optimizing for CPU and memory usage, allowing real-time analytics while standard router functions may remain unaffected. The platform may provide for flexible integration by supporting real-time event output in JSON format for downstream integration.

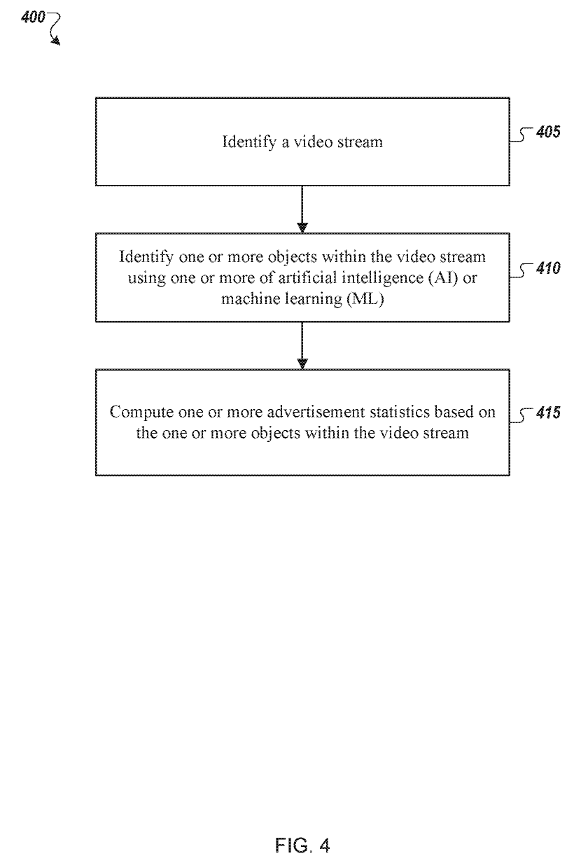

FIG. 4 illustrates a process flow of an example method 400 for video and audio analysis, in accordance with at least one example described in the present disclosure. The method 400 may be arranged in accordance with at least one example described in the present disclosure.

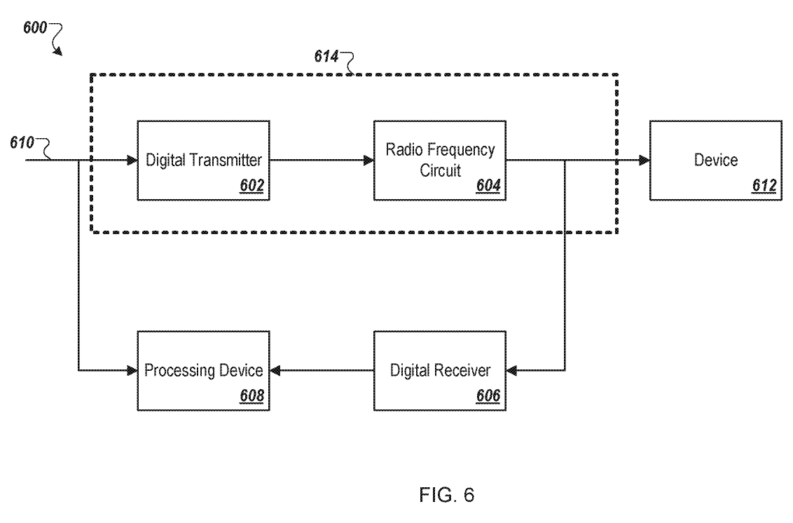

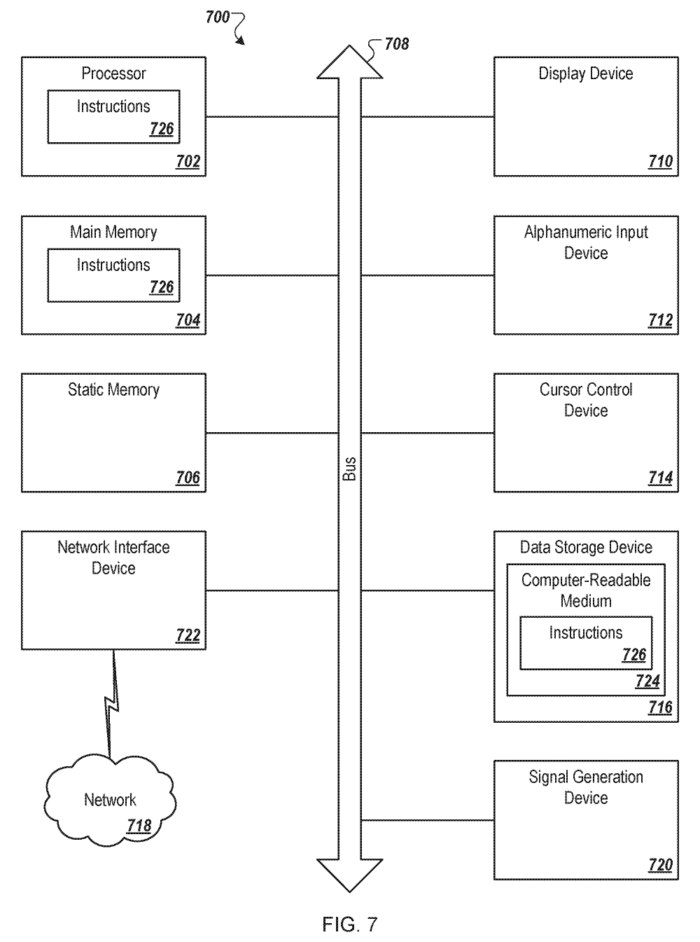

The method 400 may be performed by processing logic that may include hardware (circuitry, dedicated logic, etc.), software (such as is run on a computer system or a dedicated machine), or a combination of both, which processing logic may be included in the processing device 702 of FIG. 7, the communication system 600 of FIG. 6, or another device, combination of devices, or systems.

The method 400 may begin at block 405 where the processing logic may identify a video stream.

At block 410, the processing logic may identify one or more objects within the video stream using one or more of artificial intelligence (AI) or machine learning (ML).

At block 415, the processing logic may compute one or more advertisement statistics based on the one or more objects within the video stream.

Modifications, additions, or omissions may be made to the method 400 without departing from the scope of the present disclosure. For example, in some examples, the method 400 may include any number of other components that may not be explicitly illustrated or described.

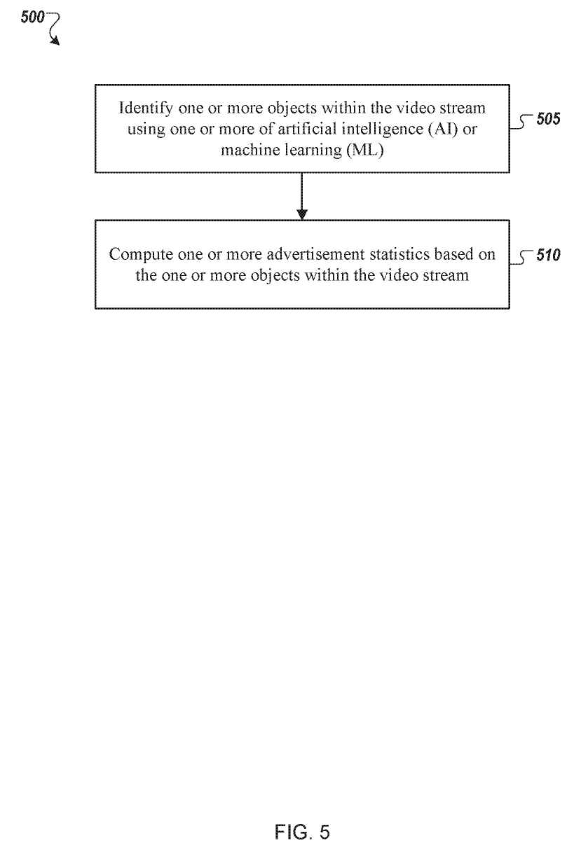

FIG. 5 illustrates a process flow of an example method 500 for video and audio analysis, in accordance with at least one example described in the present disclosure. The method 500 may be arranged in accordance with at least one example described in the present disclosure.

The method 500 may be performed by processing logic that may include hardware (circuitry, dedicated logic, etc.), software (such as is run on a computer system or a dedicated machine), or a combination of both, which processing logic may be included in the processing device 702 of FIG. 7, the communication system 600 of FIG. 6, or another device, combination of devices, or systems.

The method 500 may begin at block 505 where the processing logic may identify one or more objects within the video stream using one or more of artificial intelligence (AI) or machine learning (ML).

At block 510, the processing logic may compute one or more advertisement statistics based on the one or more objects within the video stream.

Modifications, additions, or omissions may be made to the method 500 without departing from the scope of the present disclosure. For example, in some examples, the method 500 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 6 illustrates a block diagram of an example communication system 600 for video and audio analysis, in accordance with at least one example described in the present disclosure. The communication system 600 may include a digital transmitter 602, a radio frequency circuit 604, a device 612, a digital receiver 606, and a processing device 608. The digital transmitter 602 and the processing device 608 may receive a baseband signal via connection 610. A transceiver 614 may include the digital transmitter 602 and the radio frequency circuit 604.

In some examples, the communication system 600 may include a system of devices that may communicate with one another via a wired or wireline connection. For example, a wired connection in the communication system 600 may include one or more Ethernet cables, one or more fiber-optic cables, and/or other similar wired communication mediums. Alternatively, or additionally, the communication system 600 may include a system of devices that may communicate via one or more wireless connections. For example, the communication system 600 may include one or more devices that may transmit and/or receive radio waves, microwaves, ultrasonic waves, optical waves, electromagnetic induction, and/or similar wireless communications. Alternatively, or additionally, the communication system 600 may include combinations of wireless and/or wired connections. In these and other examples, the communication system 600 may include one or more devices that may obtain a baseband signal, perform one or more operations to the baseband signal to generate a modified baseband signal, and transmit the modified baseband signal, such as to one or more loads.

In some examples, the communication system 600 may include one or more communication channels that may communicatively couple systems and/or devices included in the communication system 600. For example, the transceiver 614 may be communicatively coupled to the device 612.

In some examples, the transceiver 614 may obtain a baseband signal. For example, as described herein, the transceiver 614 may generate a baseband signal and/or receive a baseband signal from another device. In some examples, the transceiver 614 may transmit the baseband signal. For example, upon obtaining the baseband signal, the transceiver 614 may transmit the baseband signal to a separate device, such as the device 612. Alternatively, or additionally, the transceiver 614 may modify, condition, and/or transform the baseband signal in advance of transmitting the baseband signal. For example, the transceiver 614 may include a quadrature up-converter and/or a digital to analog converter (DAC) that may modify the baseband signal. Alternatively, or additionally, the transceiver 614 may include a direct radio frequency (RF) sampling converter that may modify the baseband signal.

In some examples, the digital transmitter 602 may obtain a baseband signal via connection 610. In some examples, the digital transmitter 602 may up-convert the baseband signal. For example, the digital transmitter 602 may include a quadrature up-converter to apply to the baseband signal. In some examples, the digital transmitter 602 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 602.

In some examples, the transceiver 614 may include one or more subcomponents that may be used in preparing the baseband signal and/or transmitting the baseband signal. For example, the transceiver 614 may include an RF front end (e.g., in a wireless environment) which may include a power amplifier (PA), a digital transmitter (e.g., 602), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, or the like. In some examples, a radio (e.g., a radio frequency circuit 604) of the transceiver 614 may be synchronized with the resource controller via the S-plane device, which may contribute to high-accuracy timing with respect to a reference clock.

In some examples, the transceiver 614 may obtain the baseband signal for transmission. For example, the transceiver 614 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 614 may generate a baseband signal for transmission. In these and other examples, the transceiver 614 may transmit the baseband signal to another device, such as the device 612.

In some examples, the device 612 may receive a transmission from the transceiver 614. For example, the transceiver 614 may transmit a baseband signal to the device 612.

In some examples, the radio frequency circuit 604 may transmit the digital signal received from the digital transmitter 602. In some examples, the radio frequency circuit 604 may transmit the digital signal to the device 612 and/or the digital receiver 606. In some examples, the digital receiver 606 may receive a digital signal from the RF circuit and/or send a digital signal to the processing device 608.

In some examples, the processing device 608 may be a standalone device or system, as illustrated. Alternatively, or additionally, the processing device 608 may be a component of another device and/or system. For example, in some examples, the processing device 608 may be included in the transceiver 614. In instances in which the processing device 608 is a standalone device or system, the processing device 608 may communicate with additional devices and/or systems remote from the processing device 608, such as the transceiver 614 and/or the device 612. For example, the processing device 608 may send and/or receive transmissions from the transceiver 614 and/or the device 612. In some examples, the processing device 608 may be combined with other elements of the communication system 600.

FIG. 7 illustrates a diagrammatic representation of a machine in the example form of a computing device 700 within which a set of instructions, for causing the machine to perform any one or more of the methods discussed herein, may be executed. The computing device 700 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one example, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 724 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A computer-implemented method, comprising:
identifying a video stream;
identifying one or more objects within the video stream using one or more of artificial intelligence (AI) or machine learning (ML); and
computing one or more advertisement statistics based on the one or more objects within the video stream.

2. The computer-implemented method of claim 1, further comprising:
computing object queuing delay estimation based on the one or more objects within the video stream to facilitate real-time analytics.

3. The computer-implemented method of claim 1, further comprising:
identifying one or more of a pattern, a style, or a color of the one or more objects within the video stream.

4. The computer-implemented method of claim 3, further comprising:
providing a fashion-related recommendation based on the one or more of the pattern, the style, or the color of the one or more objects within the video stream.

5. The computer-implemented method of claim 1, further comprising:
training a model based on training data and a selected training algorithm to generate a trained model; and
performing the one or more of AI or ML using the trained model.

6. The computer-implemented method of claim 1, wherein the video stream is received from one or more of a television, a set-top box, a computer, a user equipment (UE), or an access point.

7. The computer-implemented method of claim 1, further comprising performing the one or more of AI or ML using an artificial neural network.

8. A device, comprising:
a processing device operable to:
identify a video stream;
identify one or more objects within the video stream using one or more of artificial intelligence (AI) or machine learning (ML); and
computing one or more advertisement statistics based on the one or more objects within the video stream.

9. The device of claim 8, wherein the processing device is further operable to compute object queuing delay estimation based on the one or more objects within the video stream to facilitate real-time analytics.

10. The device of claim 8, wherein the processing device is further operable to identify one or more of a pattern, a style, or a color of the one or more objects within the video stream.

11. The device of claim 10, wherein the processing device is further operable to provide a fashion-related recommendation based on the one or more of the pattern, the style, or the color of the one or more objects within the video stream.

12. The device of claim 8, wherein the processing device is further operable to
train a model based on training data and a selected training algorithm to generate a trained model; and
perform the one or more of AI or ML using the trained model.

13. The device of claim 8, wherein the device is one or more of a television, a set-top box, a computer, a user equipment (UE), or an access point.

14. The device of claim 8, wherein the processing device is further operable to perform the one or more of AI or ML using an artificial neural network.

15. A system, comprising:
a multimedia device;
a device comprising;
a transceiver operable to receive a video stream from the multimedia device; and
a processing device operable to:
identify one or more objects within the video stream using one or more of artificial intelligence (AI) or machine learning (ML); and
compute one or more advertisement statistics based on the one or more objects within the video stream.

16. The system of claim 15, wherein the processing device is further operable to compute object queuing delay estimation based on the one or more objects within the video stream to facilitate real-time analytics.

17. The system of claim 15, wherein the processing device is further operable to identify one or more of a pattern, a style, or a color of the one or more objects within the video stream.

18. The system of claim 17, wherein the processing device is further operable to provide a fashion-related recommendation based on the one or more of the pattern, the style, or the color of the one or more objects within the video stream.

19. The system of claim 15, wherein the processing device is further operable to:
train a model based on training data and a selected training algorithm to generate a trained model; and
perform the one or more of AI or ML using the trained model.

20. The system of claim 15, wherein the multimedia device includes one or more of a television, a set-top box, a computer, a user equipment (UE), or an access point.
